(19) United States
(12) Patent Application Publication
(10) Pub. No.: US 2009/0249895 A1
(43) Pub. Date: Oct. 8, 2009

(54) AIR FILTER HOUSING WITH MEANS FOR MEASURING PARTICLE CONCENTRATION

(75) Inventor: Axel Mahler, Reinfeld (DE)

Correspondence Address: YOUNG & THOMPSON, 209 Madison Street, Suite 500, ALEXANDRIA, VA, 22314, US

(73) Assignee: CAMFIL AB, Trosa (SE)

(21) Appl. No.: 12/278,632

(22) PCT Filed: Mar. 14, 2006
(86) PCT No.: PCT/SE06/50029

§ 371 Date: Apr. 21, 2009

(51) Int. Cl. G01N 1/22

(52) U.S. Cl. 73/863.23

(57) ABSTRACT

An air filter housing (1) has at least one filter chamber (2, 3) for receiving at least one filter unit (F), the filter chamber having an inlet end and an outlet end, and elements (18, 19) for measuring particle concentration in the air leaving the filter chamber. The measuring elements (18, 19) include a row of several particle detectors (20) affixed to a common support (21), members (23-31) for moving the support in a direction perpendicular to the row of detectors, and members for connecting each of the detectors to a counter.

### TECHNICAL FIELD

The present invention relates to an air filter housing having at least one filter chamber for receiving at least one filter unit, said filter chamber having an inlet end and an outlet end, and means for measuring particle concentration in the air leaving the filter chamber.

### BACKGROUND OF THE INVENTION

Filter housings according to the introduction are known from filtering devices for certain laboratories or the like in which there is a risk that the ambient air will be contaminated. In order to prevent air from such environment to leak out, such laboratories often are set under sub-pressure. The function of the filter is to capture all infectious particles or other contaminations, such as bugs or other air carried infectious organisms, in the circulated air. It is thus essential that each filter functions properly and the integrity of the filters is therefore continuously (periodically?) checked.

It is known to use a particle detector being movable over the outlet area of a filter chamber to check if particles are present in the air leaving the filter in order to detect a leak in the filter media and where such a leak is located. A problem with such an arrangement is that the mechanism for moving the detector will have a complicated construction and be hard to manoeuvre.

An objective of the present invention is to provide means for measuring particle concentration in the air leaving the filter chamber in a filter housing of the kind mentioned above which means are of a simple construction and easy to manoeuvre.

### SUMMARY OF THE INVENTION

This objective is accomplished by an air filter housing having at least one filter chamber for receiving at least one filter unit, said filter chamber having an inlet end and an outlet end, and means for measuring particle concentration in the air leaving the filter chamber, characterised in that said measuring means includes a row of several particle detectors affixed to a common support, means for moving said support in a direction perpendicular to said row of detectors, and means for alternately connecting each of said detectors to a counter.

According to a preferred embodiment said moving means are a screw and nut mechanism. Especially, said support is a bar having holes with an inner thread in opposite ends thereof and said means for moving said bar are rods with an external thread fitting into said holes in said bar, said rods being rotatably mounted in the filter housing, and drive means for synchronously rotating said rods. Said drive means can be an electric motor coupled to one of said rods and a belt in engagement with drive wheels on both of said rods. A belt tensioner is advantageously disposed in the pass of the belt between the two drive wheels.

In a variant, each rod can be driven by a separate electric motor.

Said detectors are preferably mounted on said support moveable between a first and a second position in a direction parallel to the flow direction in the filter unit, whereby the detectors are biased by springs to the first position.

### BRIEF DESCRIPTION OF THE DRAWINGS

The invention shall now be described with reference to the enclosed Figures, of which;

FIG. 1 schematically discloses a perspective view of an air filter housing according to a preferred embodiment of the invention with the doors for the access openings to the two filter chambers being opened,

FIG. 2 schematically discloses a side view partially in section of the air filter housing in FIG. 1,

FIG. 3 a sectional view along line II-III in FIG. 2, and

FIG. 4 schematically discloses a side view partially in section of a part of the air filter housing in FIG. 1.

### DESCRIPTION OF EMBODIMENTS

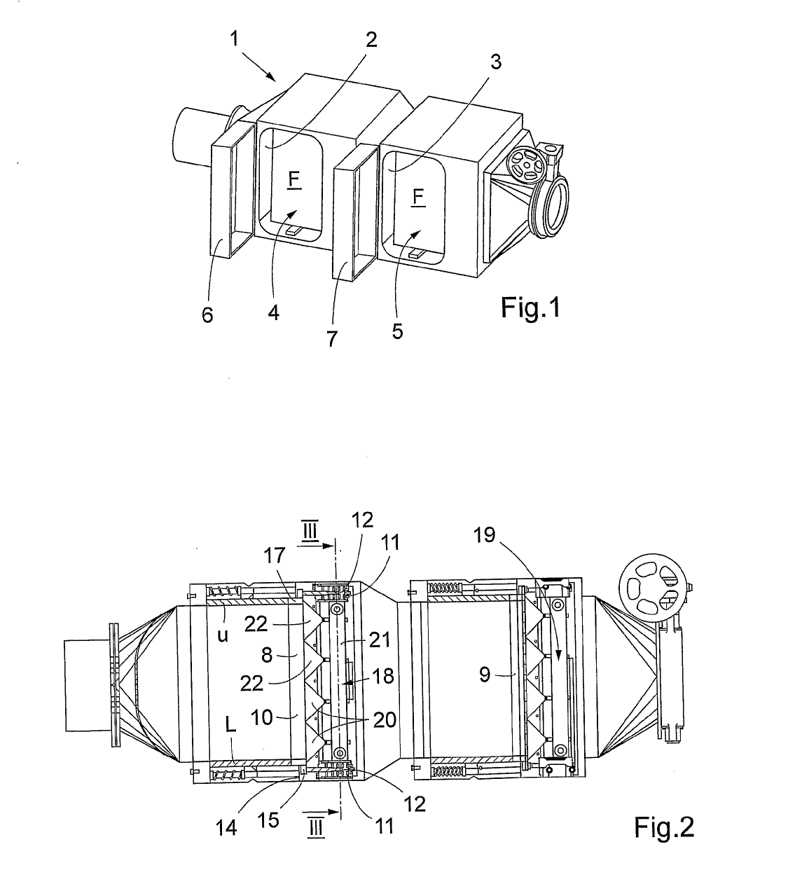

In FIG. 1, a schematic perspective view of an air filter housing 1 according to a preferred embodiment of the present invention is shown. In the preferred embodiment, the housing includes two filter chambers 2,3 in each of which an air filter unit F is disposed. Access to filter chambers 2,3 is gained by access openings 4,5. These access openings are closable by doors 6,7 shown in their open position in FIG. 1.

In FIG. 2, the filter housing 1 is shown in a partially sectioned plan view seen from the side of the housing 1 containing the access openings 4,5. The doors 6,7 are not shown in FIG. 2. As can be seen in FIG. 2, each filter unit F comprises a circumferential wall surrounding the filter media and ensuring that air passing through the filter unit will not sidewise leak out of the filter unit but pass through the unit from one end to the other, i.e. in the longitudinal direction of the filter housing 1. In FIG. 2 the upper U and lower part L of this circumferential wall of a filter unit F disposed within filter chamber 2 are shown. When the filter is in operation, the filter units F are held in the filter chambers 2,3 by clamping devices 8 and 9, respectively.

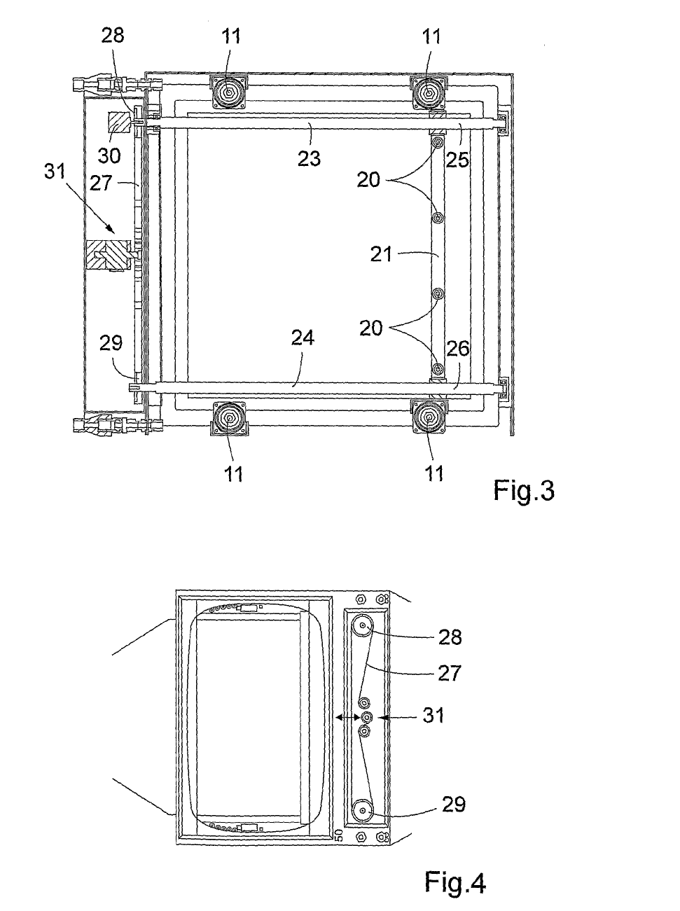

Clamping device 8 consists of a frame 10 which is movable back and forth in the flow direction of the air or gas passing through the filter unit F. In the preferred embodiment shown, the means for moving the frame 10 are four pneumatic cylinders 11, of which two are shown in FIG. 2. These pneumatic cylinders can be disposed in the corners of the rectangular frame 10 or in pairs distanced from the corners on the upper and lower frame parts or the side parts of the frame, as is shown in FIG. 3. It is of course possible, but not preferred, to use more than four pneumatic cylinders and also possible to use three cylinders disposed in a triangular pattern. In FIG. 2 the frame 10 is shown in its operative position in which the frame 10 presses the distal end of the filter unit F, i.e. the end being distal from the frame, against a first end wall of the filter chamber 2 and is itself pressed against the proximal end of the filter unit. The filter unit F is provided with sealing elements (not shown in the Figures), such as sealing rings or the like, affixed to the opposite ends of the circumferential wall surrounding the filter media. The frame 10 is biased towards the operative position by compression springs 12 acting on the piston of each cylinder 11. The sealing elements on each end of the filter unit F is somewhat compressed due to the compressive force from the springs 12 thereby ensuring that air entering the filter housing can not leak out between the first end wall of the filter chamber 2 and the distal end of the circumferential wall of a filter unit F placed in the filter chamber or between the proximal end of this wall and the frame 10. Each cylinder 12 also contains connections (not shown) to a pressure source for moving the pistons of the cylinders 11 against the force of the springs 12 and thereby move the frame 10 to the right in FIG. 2 when a filter unit F placed within the filter chamber 2 is to be discharged and replaced by a fresh filter unit.

A circumferential flange 14 is projecting inwardly from the outer wall of the filter housing 1 in the second end of the filter chamber 2. In the operative position of the frame 10, a portion 15 of the frame 10 is in abutment with the flange 14 via a sealing element. This sealing element, for example an O-ring, can be affixed to flange 14 or frame 10. By this arrangement it is ensured that air or gas that have passed through the filter unit F placed within the filter chamber 2 can not enter the space outside the circumferential wall of the filter unit, i.e. the space to the left of flange 14 or the space between the first end wall of the filter chamber and the flange 14 in FIG. 2. This space contains the access opening 4 to the filter chamber. Thereby it is ensured that no contaminated air or decontamination gas will leak out of the access opening during operation of the filter or thereafter even if the sealing of the access opening is not tight. A double security is thus obtained.

In order to be able to push a filter unit F towards the end wall of the filter chamber 2, i.e. to the left in FIGS. 1 and 2, the frame 10 has a first tubular part 17 having an outer circumference smaller than an inner circumference of the circumferential flange 14 and a second tubular part 15 having an outer circumference larger than the inner circumference of the circumferential flange 14, the second tubular part having a smaller longitudinal extension than the first tubular part 17 and being disposed in the portion of the frame 10 being proximal to the pneumatic cylinders 11. Thereby, the part 17 can be moved in the longitudinal direction without being obstructed by the flange 14. The width of the second tubular part 15 is chosen such as the O-ring affixed to the frame or the flange is compressed when the frame 10 is in operative position pressing the filter unit F against the first end wall of the filter chamber 2.

The second filter chamber 3 is constructed the same way as filter chamber 2 and includes also a clamping device 9 similar to the clamping device 10,11 described above.

A device 18,19 for monitoring the integrity of the filter unit F in filter chambers 2 and 3 is mounted in the filter housing 1 at the outlet from the respective filter chamber 2,3. The monitoring device 19 is identical to the device 18.

The integrity of the filter unit is monitored by measuring the particle concentration in the air leaving the filter unit in order to establish if the filter is leaking, i.e. if one or more holes in the filter media allow particles to pass through the filter media. It is also important to locate even very small leaks which means that the particle concentration in relatively small volumes of air must be studied. The monitoring device 18 therefore comprises OPC:s (Optical Particle Counter) sampling relatively small volumes of the air leaving the filter unit F. In order to cover the whole area of the filter unit, the OPC:s need to be movable so that all air leaving the filter unit will be monitored by the device 18.

The device 18 comprises a row of several detectors (OPC:S) 20 mounted on a tubular bar 21 with a rectangular cross-section. The inlet end of each detector 20 comprises a funnel 22 having circular cross-sections and the row of detectors comprise as many detectors as needed for the funnels to cover the whole length of a side of the outlet area of filter chamber 2. In the disclosed embodiment four detectors are present in the row of detectors 20. The numbers of detectors needed is of course dependent on the length of the side of the area to be covered but also on the size of the funnel 22 which means that both more or fewer detectors can be used within the scope of invention. The term “several” means in this context “at least two”.

In order to cover the whole area of the outlet from the filter chamber, the row of detectors is movable from one side of the outlet area of the filter chamber to the opposite side thereof. To accomplish this, two rotatable rods 23,24 having an external thread over the major part of their length are threaded into holes 25,26 in the respective ends of bar 21, said holes 25,26 having an inner thread. Thus, by rotating the rods 23,24 in one or the other direction, the bar 21 and thereby the detectors 20 will move towards or away from the side of the outlet area of the filter chamber, i.e. to the left or right in FIG. 3. The rods 23,24 are rotatably mounted in opposite side walls of filter housing and drivingly in connection with each other via a belt 27 acting on drive wheels 28,29. The end of rod 23 is connected to the output shaft of an electric motor 30. Rotation of rod 23 by the motor 30 is thus synchronously transmitted from the drive wheel 28 to rod 24 via the belt 27 acting on the drive wheel 29.

A belt tensioner 31 is preferably arranged in the path of the belt 27. Said tensioner is schematically shown in FIGS. 3 and 4 and comprises a spring device (not shown) biasing the middle of the three rollers disclosed in FIG. 4 to the right in FIG. 4 as indicated by an double-arrow in this Figure. However, any type of belt tensioner can be used.

By appropriate control of the electric motor 30, the row of detectors 20 can thus be moved from one side to the other side of the outlet area of the filter chamber and back again. During a movement from a first side to the opposite, second side of the outlet area of the filter chamber only one of the detectors 20 is connected to a central counter (not shown) which calculates the particle concentration based on the number of signals from the detector and the flow rate of the air flowing through the detector and stores the values calculated this way. When one detector 20 has traveled from one side to the other side of the outlet area of the filter chamber, the central counter switch from this detector to the next detector 20 in the row and registers the values of the particle concentration from the latter detector during the return travel of the row of detectors from the second side to the first side. Thereafter, the next detector in the row is connected to the central counter and during the return travel of the row of detectors the last of the detectors 20 is connected to the counter.

Since each detector 20 only travels in a straight line, the moving mechanism for the detectors can be of extremely simple construction and be both accurate and reliable. Reliability is a very important factor for a filter housing used in a contaminated environment.

As is evident from FIG. 2, the openings of the funnels 22 of the detectors 20 lie in the same plane as the right edge of the frame 10 and portions of the funnels are also extending over said frame. In FIG. 2, the frame 10 is shown in its operative position clamping the filter unit F but when a used filter unit is to be discharged and substituted by a fresh one, the frame 10 is moved to the right in FIG. 2 with the aid of the pneumatic cylinders 11. In order to allow such a movement of the frame 10, the detectors 20 are movably attached to bar 21 so that they can follow the movement of the frame 10 from operative to inoperative position. This is for example accomplished by mounting the detectors slidable within holes in the bar 21. Preferably, the detectors 20 are biased towards the operative position of frame 10 by springs.

The described embodiment can of course be modified in several ways without leaving the scope of invention. For example, the funnels 22 can have another cross-sectional shape than circular, e.g. rectangular or square, and other conicity than shown in FIG. 2. The bar 21 can also have another cross-sectional shape than rectangular, for example circular or oval, in order to have a more aerodynamic shape. The belt drive of rod 24 can be deleted and this rod be without an external thread in which case the hole 26 will be without inner thread. The movement of the bar 21 will then be performed only by the electric motor 30 and the rod 24 will only function as a guide rod. It is of course also possible to use one electric motor for each of the rods 23,24. Other types of detectors than OPC:s can be used. Furthermore, the central counter can be programmed to simultaneously read the signals from all of the detectors instead of only one detector at a time. The present invention should therefore only be restricted by the content of the enclosed patent claims.

1. An air filter housing (1) having at least one filter chamber (2,3) for receiving at least one filter unit (F), said filter chamber having an inlet end and an outlet end, and means (18,19) for measuring particle concentration in the air leaving the filter chamber, characterised in that said measuring means (18,19) include a row of several particle detectors (20) affixed to a common support (21), means (23-31) for moving said support in a direction perpendicular to said row of detectors, and means for connecting each of said detectors to a counter.

2. An air filter housing (1) according to claim 1, wherein said moving means (23-31) are a screw and nut mechanism.

3. An air filter housing (1) according to claim 2, wherein said support is a bar (21) having holes (25,26) with an inner thread in opposite ends thereof and said means for moving said bar (21) are rods (23,24) with an external thread fitting into said holes in said bar, said rods being rotatably mounted in the filter housing, and drive means (27-31) for synchronously rotating said rods.

4. An air filter housing (1) according to claim 3, wherein said drive means is an electric motor (30) coupled to one (23) of said rods (23,24) and a belt (27) in engagement with drive wheels (28,29) on both of said rods.

5. An air filter housing (1) according to claim 4, wherein a belt tensioner (31) is disposed in the pass of the belt (27) between the two drive wheels (28,29).

6. An air filter housing (1) according to claim 3, wherein each rod is driven by a separate electric motor.

7. An air filter housing (1) according to claim 1, wherein said detectors (20) are mounted on said support (21) moveable between a first and a second position in a direction parallel to the flow direction in the filter unit (F), whereby the detectors (20) are biased by springs to the first position.

8. An air filter housing (1) according to claim 2, wherein said detectors (20) are mounted on said support (21) moveable between a first and a second position in a direction parallel to the flow direction in the filter unit (F), whereby the detectors (20) are biased by springs to the first position.

9. An air filter housing (1) according to claim 3, wherein said detectors (20) are mounted on said support (21) moveable between a first and a second position in a direction parallel to the flow direction in the filter unit (F), whereby the detectors (20) are biased by springs to the first position.

10. An air filter housing (1) according to claim 4, wherein said detectors (20) are mounted on said support (21) moveable between a first and a second position in a direction parallel to the flow direction in the filter unit (F), whereby the detectors (20) are biased by springs to the first position.

11. An air filter housing (1) according to claim 5, wherein said detectors (20) are mounted on said support (21) moveable between a first and a second position in a direction parallel to the flow direction in the filter unit (F), whereby the detectors (20) are biased by springs to the first position.

12. An air filter housing (1) according to claim 6, wherein said detectors (20) are mounted on said support (21) moveable between a first and a second position in a direction parallel to the flow direction in the filter unit (F), whereby the detectors (20) are biased by springs to the first position.
